(19) United States
(12) Patent Application Publication
(10) Pub. No.: US 2025/0378649 A1
(43) Pub. Date: Dec. 11, 2025

(54) SYSTEM AND METHOD FOR ESTABLISING AUGMENTED REALITY AND AUGMENTED REALITY POSITIONING GUIDANCE METHOD

(71) Applicants: INVENTEC (PUDONG) TECHNOLOGY CORPORATION, Shanghai (CN); INVENTEC CORPORATION, Taipei City (TW)

(72) Inventor: Chia-Hao YEH, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/943,619

(22) Filed: Nov. 11, 2024

(30) Foreign Application Priority Data
Jun. 5, 2024 (CN) 202410727508.5

(51) Int. Cl. G06T 19/00; G06T 19/20

(52) U.S. Cl. CPC G06T 19/006; G06T 19/20; G06T 2219/2004; G06T 2219/2016

(57) ABSTRACT

This system is designed for establishing augmented reality and includes the following components: an optical radar configured to scan a real scene to obtain three-dimensional spatial information, where the scene includes a target object of a first size; and a processor connected to the optical radar. The processor converts the three-dimensional spatial information into a point cloud map and executes a virtual environment development engine. This engine creates a virtual scene corresponding to the real scene and generates a virtual object corresponding to the target object based on the point cloud map. The virtual object has a second size, set according to a default proportional relationship, and the engine establishes augmented reality elements around the virtual object to present operational content related to the target object.

### CROSS-REFERENCE TO RELATED APPLICATIONS

This non-provisional application claims priority under 35 U.S.C. § 119(a) on Patent Application No(s). 202410727508.5 filed in China on Jun. 5, 2024, the entire contents of which are hereby incorporated by reference.

### BACKGROUND

### 1. Technical Field

The present disclosure relates to Augmented Reality (AR), particularly to a system and method for establishing augmented reality and a positioning guidance method based on augmented reality.

### 2. Related Art

Inspectors in factories regularly maintain various equipment to carry out production operations. When inspectors arrive at the worksite, they check equipment information through the Human Machine Interface (HMI) and then log into the workstation computer to review production-related information.

However, the current practice requires inspectors to collect information from various sources and integrate it themselves, leading to inefficiencies in operations. Additionally, inspectors face various inconveniences. For example, most existing training for production operations adopts a mentorship system, but the transmission of human experience is not easy. If new inspectors cannot quickly learn the knowledge they should possess, there will be gaps in the factory inspection process. Furthermore, some special operational procedures require significant expertise, and their techniques are difficult to replicate. If an inspector responsible for special operational procedures is unable to attend for any reason, it will result in a manpower shortage.

### SUMMARY

In light of the above descriptions, the present disclosure provides a method for establishing augmented reality, a system for establishing augmented reality and an augmented reality positioning guidance method.

According to one or more embodiment of the present disclosure, a method for establishing augmented reality includes the following steps: scanning a real scene by an optical radar to obtain three-dimensional spatial information, wherein the real scene includes a target object with a first size; converting the three-dimensional spatial information into a point cloud map by a processor; executing a virtual environment development engine by the processor to create a virtual scene corresponding to the real scene and to create a virtual object corresponding to the target object according to the point cloud map, wherein the virtual object has a second size; setting the second size of the virtual object according to a default proportional relationship by the virtual environment development engine; and creating an augmented reality element around the virtual object by the virtual environment development engine to present an operational content corresponding to the target object.

According to one or more embodiment of the present disclosure, an augmented reality positioning guidance method includes the following steps: scanning a real scene by an optical radar to obtain three-dimensional spatial information, wherein the real scene includes a target object with a first size; converting the three-dimensional spatial information into a point cloud map by a processor; executing a virtual environment development engine by the processor to create a virtual scene corresponding to the real scene and to create a virtual object corresponding to the target object according to the point cloud map, wherein the virtual object has a second size; setting the second size of the virtual object according to a default proportional relationship by the virtual environment development engine; creating an augmented reality element around the virtual object by the virtual environment development engine to present an operational content corresponding to the target object; setting a real environment positioning information of the augmented reality element in the virtual scene by the virtual environment development engine; obtaining a current position by a positioning module; capturing the target object in the real scene by a camera module to generate a first image when the current position matches a predefined position; loading the virtual object and the augmented reality element according to the first image and the predefined position by a processing module; adjusting a display size of the operational content according to the default proportional relationship by the processing module; and controlling a display module to show an augmented reality image that includes the first image and the operational content by the processing module.

According to one or more embodiment of the present disclosure a system for establishing augmented reality includes an optical radar and a processor. The optical radar is configured to scan a real scene to obtain three-dimensional spatial information, wherein the real scene includes a target object with a first size. The processor is communicably connected to the optical radar, wherein the processor is configured to convert the three-dimensional spatial information into a point cloud map and execute a virtual environment development engine, wherein the virtual environment development engine is configured to create a virtual scene corresponding to the real scene and create a virtual object corresponding to the target object according to the point cloud map, the virtual object has a second size, the virtual environment development engine is further configured to set the second size of the virtual object according to a default proportional relationship and create an augmented reality element around the virtual object to present an operational content corresponding to the target object.

In summary, the present disclosure proposes a system and method for establishing augmented reality. The system and method achieve the integration of augmented reality by merging virtual constructed objects with real scenes, using virtual elements to guide operations in real scenes. The system and method utilize a virtual environment development engine to build a virtual environment, restore the operational space of the real scene, create icons, digital billboards, dialog boxes, and other operational elements, and then link these operational elements with functional trigger content, designing activation procedures and trigger conditions. This allows for customized step-by-step guidance for inspectors based on scene requirements, covering applications such as troubleshooting, training, and information navigation. The completed augmented reality system, linked to a production management system, can achieve an operational interaction mechanism, where behaviors in the virtual environment can trigger real operational systems and provide real-time feedback on operational status and condition updates. The augmented reality positioning guidance method proposed in the present disclosure identifies objects through augmented reality technology, then fits the coordinates of the virtual space with those of the real space, achieving a positioning capability with an error control within 1 meter. Furthermore, through enhanced recognition of auxiliary feature points, positioning can be further strengthened for the working components of the target object, allowing the positioning accuracy to be controlled within 0.3 meters.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a system for establishing augmented reality according to an embodiment of the present disclosure;

FIG. 2 is a flowchart of a method for establishing augmented reality according to an embodiment of the present disclosure;

FIG. 3 is a flowchart of an augmented reality positioning guidance method according to an embodiment of the present disclosure;

FIG. 4 is a flowchart for correcting the current position according to an embodiment of the present disclosure; and

FIG. 5 is a flowchart for calculating a compensation value according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

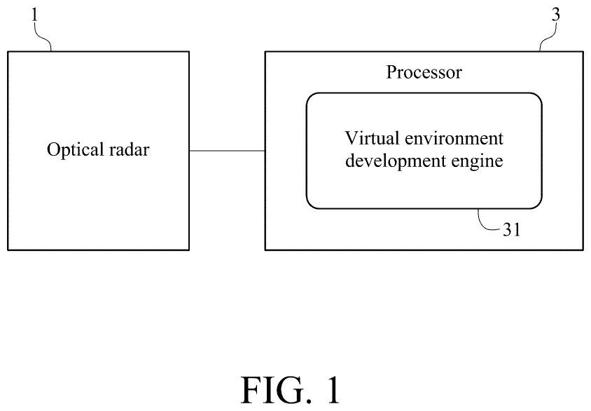

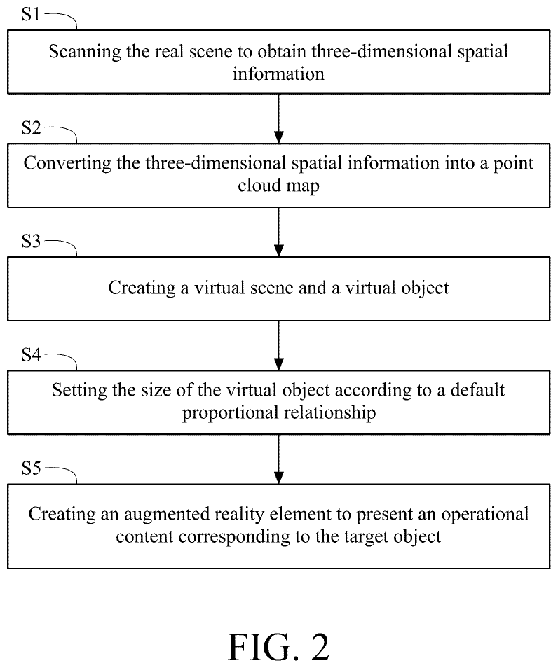

FIG. 1 is a block diagram of a system for establishing augmented reality according to an embodiment of the present disclosure. As shown in FIG. 1, the system for establishing augmented reality includes an optical radar 1 and a processor 3. FIG. 2 is a flowchart of a method for establishing augmented reality according to an embodiment of the present disclosure, which includes steps S1 to S5. The method is applicable to the system for establishing augmented reality shown in FIG. 1, and the details of each device in FIG. 1 will be explained in conjunction with the flowchart shown in FIG. 2.

In step S1, the optical radar 1 scans the real scene to obtain three-dimensional spatial information. The optical radar 1 refers to any device used for scanning mapping data. In an embodiment, at least one of the following examples can be used as the optical radar 1: Time of Flight (ToF) camera, Light Detection and Ranging (LiDAR) scanner, depth sensor, infrared rangefinder, ultrasonic sensor, or other range-related sensors. The real scene includes a target object of a first size. For example, the real scene could be a worksite such as a factory, where the workstation is the target object, but the present disclosure is not limited to this.

In step S2, the processor 3 converts the three-dimensional spatial information into a point cloud map. In an embodiment, the processor 3 is configured to obtain size data of the workstations from the specifications as the aforementioned first size. The processor 3 is communicably connected to the optical radar 1 to receive the three-dimensional spatial information. The processor 3 is configured to convert the three-dimensional spatial information into the point cloud map. In an embodiment, the processor 3 may be a Central Processing Unit (CPU), a Graphic Processing Unit (GPU), or other programmable general-purpose or special-purpose microprocessors, Digital Signal Processors (DSPs), programmable controllers, Field Programmable Gate Arrays (FPGA), Application-Specific Integrated Circuits (ASIC), neural network accelerators, or other similar components or combinations thereof.

In step S3, the processor 3 executes a virtual environment development engine 31 to create a virtual scene and a virtual object. In an embodiment, the virtual environment development engine 31 is Unity, which establishes the virtual object corresponding to the target object based on three-dimensional remapping technology and the point cloud map, and then embeds the virtual scene corresponding to the real scene created in Unity.

In step S4, the virtual environment development engine 31 sets a second size of the virtual object according to a default proportional relationship. In an embodiment, augmented reality developers pre-determine the default proportional relationship between the real scene and the virtual scene, for example, 100 to 1, and then calculate the second size of the virtual object based on this default proportional relationship and the first size of the target objects. In other words, the processor 3 obtains a two-dimensional layout field map corresponding to the real scene, imports it into the virtual environment development engine 31 for spatial comparison. The virtual environment development engine 31 performs proportional conversion based on pixel scale and field layout distance. Since the unit measures of the virtual scene differ from those of the real scene, mutual comparison is needed to confirm how many pixels in the virtual scene correspond to one meter in the real scene.

In step S5, the virtual environment development engine 31 creates an augmented reality element around the virtual object to present an operational content corresponding to the target object. The augmented reality elements may include virtual icons, virtual panels, virtual dialogue boxes, etc., and the present disclosure is not limited to this. In an embodiment, after the augmented reality developers import three-dimensional virtual object into Unity software, they drag them into the virtual scene built in Unity and freely place virtual icons (such as buttons, arrows, dialogue boxes) in key positions for subsequent inspectors to view or interact with.

In an embodiment, the virtual environment development engine 31 is further configured to set the reality environment positioning information of the augmented reality element in the virtual scene, a message code, a trigger condition and an activation procedure corresponding to the message code. For example, the augmented reality element is a button represented by a virtual icon, with the bound message code being Ab001. The trigger condition is a touch action by the inspector, and the activation procedure is to open the standard operating procedure (SOP) document for the workstation. Subsequently, when the touch action by the inspector is detected, the corresponding message code Ab001 will be generated, and the backend database will automatically schedule the projection of the SOP document around the virtual object based on this message code, with the presentation position needing to be pre-set.

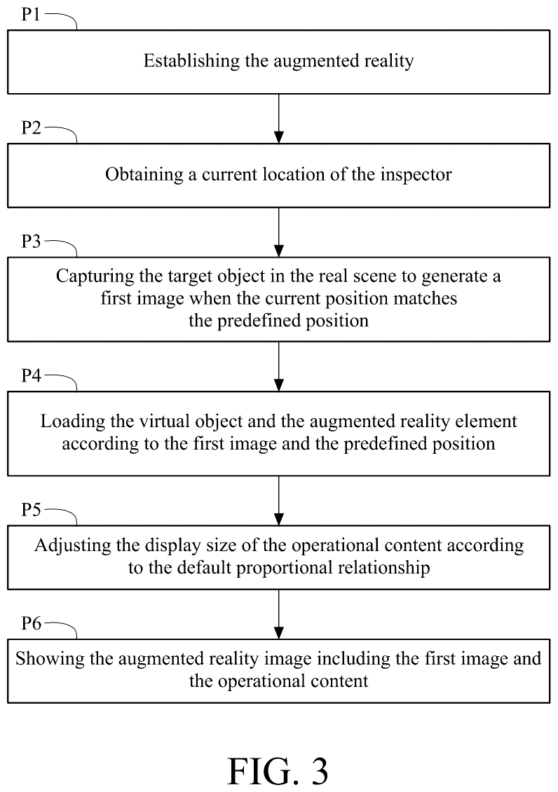

FIG. 3 is a flowchart of an augmented reality positioning guidance method according to an embodiment of the present disclosure. The applicable scenario for this method is when inspectors carry augmented reality application devices for inspections. In an embodiment, the augmented reality application device may be a smartphone, tablet, head-mounted device, or smart glasses (such as Microsoft HoloLens), and the present disclosure is not limited to these. The augmented reality application device includes at least: a camera module, a positioning module, and a processing module. The display module may be the screen of a tablet or the lenses of a head-mounted device.

In step P1, the optical radar 1 and processor 3 perform the method shown in FIG. 2 to establish augmented reality.

In step P2, the positioning module obtains a current location of the inspector. In an embodiment, the positioning module includes an inertial positioning component, a wireless signal positioning component, and a processing component. The processing component connects the inertial positioning component and the wireless signal positioning component. The inertial positioning component is configured to generate inertial positioning information. Implementations of the inertial positioning component may include at least one of the following examples: gyroscope, accelerometer, and magnetometer. The wireless signal positioning component is configured to generate wireless signal positioning information. The wireless communication standards supported by the wireless signal positioning component may include at least one of the following examples: 5^{th} Generation mobile networks (5G), Bluetooth, Wi-Fi, ZigBee, and Low Power Wide Area Networks (LPWAN, such as LoRa, Sigfox, NB-IOT, etc.) The processing component is configured to generate device location information according to the inertial positioning information and wireless signal positioning information. The processing component generates a three-dimensional coordinate and an orientation angle through a hybrid positioning engine. Implementations of the processing component may include at least one of the following examples: personal computer, network server, microcontroller (MCU), application processor (AP), field programmable gate array (FPGA), application-specific integrated circuit (ASIC), system-on-a-chip (SoC), deep learning accelerator, or any electronic device with similar functions, but the present disclosure does not limit the hardware type of the processing component.

In step P3, when the current position matches the predefined position, the camera module captures the target object in the real scene to generate a first image. The predefined position may, for example, be the location of the target object in the real scene.

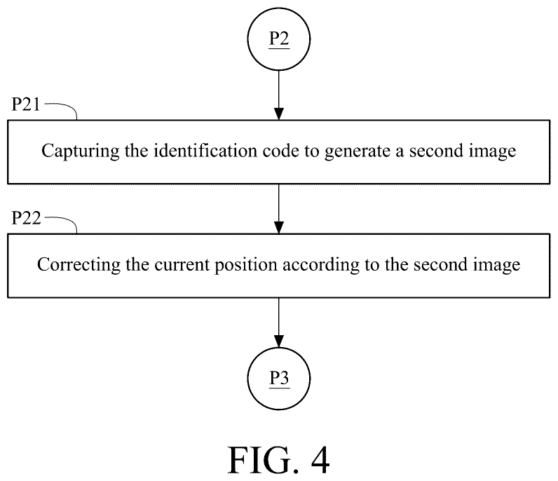

In an embodiment, a process for correcting the current position, as shown in FIG. 4, is further included between steps P2 and P3. The target object has a working component, such as physical button or switch on the workstation. The working component has an identification code, such as a QR code or a sticker with a specific pattern. After the inspector arrives near the target object, as shown in step P21, the identification code can be captured by the camera module to generate a second image. In step P22, the processing module corrects the current position according to the second image; for example, it may decode the QR code or use image recognition. Since the positions of the stickers and icons are known fixed locations, the current positional coordinates can be further corrected by scanning the identification code.

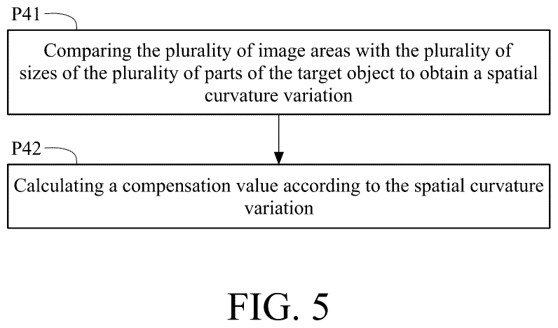

In step P4, the processing module loads the virtual object and the augmented reality element according to on the first image and the predefined position. In step P5, the processing module adjusts the display size of the operational content according to the default proportional relationship. In an embodiment, steps P4 and P5 further include a process for calculating a compensation value, as shown in FIG. 5. Specifically, the first image includes a plurality of sub-images, these sub-images cover different image areas of the first image, these image areas correspond to a plurality of parts of the target object. In step P41, the processing module compares the plurality of image areas with a plurality of sizes of the plurality of parts of the target object by the processing module to obtain a spatial curvature variation. In step P42, the processing component calculates a compensation value according to the spatial curvature variation. Then, in step P5, in addition to adjusting according to the default proportional relationship, the processing module also adjusts the display size of the operational content according to the compensation value. This embodiment takes into account that identifying objects in augmented reality requires scanning through a lens, and the video distortion caused by the lens will also affect the positional coordinates in space. Therefore, a grid area can be pre-set within the video range, and objects can be placed to confirm the size variations of each object, thereby determining the curvature changes in space. Through multi-dimensional object proportion conversion, a reasonable compensation value can be calculated within the video space.

In step P6, the processing module controls the display module to show the augmented reality image, which includes the first image and operational content.

Overall, the method and augmented reality positioning guidance method proposed by the present disclosure include both the integration of augmented reality with reality and positioning guidance. Establishing a virtual space involves processes such as icon creation, virtual environment positioning, message code assignment, and event procedure definition. In the real space, it includes processes such as real environment positioning, digital billboard projection, icon touch tracking, and event guidance.

In view of the above, the present disclosure proposes a system and method for establishing augmented reality. The system and method achieve the integration of augmented reality by merging virtual constructed objects with real scenes, using virtual elements to guide operations in real scenes. The system and method utilize a virtual environment development engine to build a virtual environment, restore the operational space of the real scene, create icons, digital billboards, dialog boxes, and other operational elements, and then link these operational elements with functional trigger content, designing activation procedures and trigger conditions. This allows for customized step-by-step guidance for inspectors based on scene requirements, covering applications such as troubleshooting, training, and information navigation. The completed augmented reality system, linked to a production management system, can achieve an operational interaction mechanism, where behaviors in the virtual environment can trigger real operational systems and provide real-time feedback on operational status and condition updates. The augmented reality positioning guidance method proposed in this disclosure identifies objects through augmented reality technology, then fits the coordinates of the virtual space with those of the real space, achieving a positioning capability with an error control within 1 meter. Furthermore, through enhanced recognition of auxiliary feature points, positioning can be further strengthened for the working components of the target object, allowing the positioning accuracy to be controlled within 0.3 meters.

In an embodiment of the present disclosure, the system and method for establishing augmented reality and the augmented reality positioning guidance method can be applied in systems composed of 5G private networks and 5G small base stations.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. A method for establishing augmented reality, comprising:
scanning, by an optical radar, a real scene to obtain three-dimensional spatial information, wherein the real scene comprises a target object with a first size;
converting, by a processor, the three-dimensional spatial information into a point cloud map;
executing, by the processor, a virtual environment development engine to create a virtual scene corresponding to the real scene and to create a virtual object corresponding to the target object according to the point cloud map, wherein the virtual object has a second size;
setting, by the virtual environment development engine, the second size of the virtual object according to a default proportional relationship; and
creating, by the virtual environment development engine, an augmented reality element around the virtual object to present an operational content corresponding to the target object.

2. The method for establishing augmented reality of claim 1, wherein the virtual environment development engine is Unity.

3. The method for establishing augmented reality of claim 1, further comprising:
setting, by the virtual environment development engine, a real environment positioning information of the augmented reality element in the virtual scene.

4. The method for establishing augmented reality of claim 1, further comprising:
setting, by the virtual environment development engine, a message code of the augmented reality element; and
setting, by the virtual environment development engine, a trigger condition and an activation procedure corresponding to the message code.

5. An augmented reality positioning guidance method, comprising:
performing, by the optical radar and the processor, the method for establishing augmented reality of claim 3;
obtaining, by a positioning module, a current position;
capturing, by a camera module, the target object in the real scene to generate a first image when the current position matches a predefined position;
loading, by a processing module, the virtual object and the augmented reality element according to the first image and the predefined position;
adjusting, by the processing module, a display size of the operational content according to the default proportional relationship; and
controlling, by the processing module, a display module to show an augmented reality image that comprises the first image and the operational content.

6. The augmented reality positioning guidance method of claim 5, wherein the target object has a working component with an identification code, and the method further comprising:
capturing, by the camera module, the identification code to generate a second image; and
correcting, by the processing module, the current position according to the second image.

7. The augmented reality positioning guidance method of claim 5, wherein the first image comprises a plurality of sub-images, each of the plurality of sub-images covers a plurality of image areas of the first image, the plurality of image areas corresponds to a plurality of parts of the target object, and the method further comprising:
comparing, by the processing module, the plurality of image areas with a plurality of sizes of the plurality of parts of the target object to obtain a spatial curvature variation;
calculating, by the processing module, a compensation value according to the spatial curvature variation; and
adjusting, by the processing module, the display size of the operational content according to the compensation value.

8. The augmented reality positioning guidance method of claim 5, wherein the current position comprises a three-dimensional coordinate and an orientation angle.

9. A system for establishing augmented reality, comprising:
an optical radar configured to scan a real scene to obtain three-dimensional spatial information, wherein the real scene comprises a target object with a first size; and
a processor communicably connected to the optical radar, wherein the processor is configured to convert the three-dimensional spatial information into a point cloud map and execute a virtual environment development engine, wherein the virtual environment development engine is configured to create a virtual scene corresponding to the real scene and create a virtual object corresponding to the target object according to the point cloud map, the virtual object has a second size, the virtual environment development engine is further configured to set the second size of the virtual object according to a default proportional relationship and establish an augmented reality element around the virtual object to present an operational content corresponding to the target object.

10. The system for establishing augmented reality of claim 9, wherein the virtual environment development engine is further configured to set a message code of the augmented reality element in the virtual scene, and to set a trigger condition and an activation procedure corresponding to the message code.
